(19) United States
(12) Patent Application Publication
(10) Pub. No.: US 2013/0055650 A1
(43) Pub. Date: Mar. 7, 2013

(54) Modular Integrated Underground Utilities Enclosure and Distribution System

(71) Applicant: Udo Hartmann, Amberg (DE)

(72) Inventor: Udo Hartmann, Amberg (DE)

(21) Appl. No.: 13/297,843

(22) Filed: Nov. 16, 2011

Related U.S. Application Data
(60) Provisional application No. 61/414,743, filed on Nov. 17, 2010.

(51) Int. Cl. E04H 5/00; E02D 29/14; E04G 21/14; H02G 9/00

(52) U.S. Cl. 52/20; 52/169.6; 52/124.1

(57) ABSTRACT

A modular underground utilities vault enclosure and distribution system providing an integrated utilities interconnection system within a single modular enclosure and a single unified set of utility service connections leading from the vault to the premises of one or several utilities customers. The vault design comprises a set of modules suitable for assembly at the user site within a suitable excavation. The unified design permits installation of all utilities service lines within a single one-time trench connecting the vault to each of one or several premises through a common service-entry module. The vault assembly enables utilities access within the vault for connecting main utilities lines to individual premises utilities line sets. Each utility can service its own lines within the vault connecting to each premises served. The individual vault modules include assembly and alignment and interface aids to resist lateral displacement forces and seal the vault against groundwater leakage.

### CROSS REFERENCE TO RELATED APPLICATIONS

This application is based on and claims the benefit of priority from Provisional Application No. 61/414,743 filed on Nov. 17, 2010, the contents of which are incorporated by reference.

### BACKGROUND OF THE INVENTION

Within the United States and in most parts of the world, utilities services including sanitary sewer lines, water lines, electric power lines, telecommunications cabling and data transmission infrastructure are in almost all cases independently installed and serviced in both old and new residential and commercial construction. Each utility provider is responsible for the installation of its own lines and connections from customer premises to the associated main utility line serving the area. When new underground lines are installed in areas with existing underground utilities service, there exists a significant risk that the existing utilities will be disturbed or connections damaged by the attendant re-trenching. Further, even during initial installation within a new subdivision, office, or industrial park the multiple trenching operations, each for its own utility, impose significant expense and risk on the project. The present invention seeks to significantly reduce the initial installation cost of combined utilities serves, the risk of disturbing other utility lines, and the cost of upgrading or repair to such services by enabling a unified installation of all utilities within a single integrated service system, using a single trench and adaptable conduits to service each utilities customer premises. Further, by using a modular design, the invention provides a very adaptable overall utility interconnection means at minimum expense through the varied assembly of a few standard modules to form the protective underground grade level vault within which all utilities connections and distributions are made. These modules allow the overall depth of the utilities vaults to be varied as well as the location, size and number of main line and distribution line entries into and out of the vault.

### BRIEF SUMMARY OF THE INVENTION

The invention comprises an underground utilities vault and distribution enclosure system which provides an integrated interconnection means for all common utilities within a single modular vault enclosure which integrates a single set of main utility line connections and a single system of unified service lines to the individual premises of one or several utilities subscribers or customers served through the integrated utility vault. The vault and its distribution system are of modular design, allowing different enclosure depths and connection configurations to be achieved using a common set of enclosure depths and connection configurations to be achieved using a common set of assembly modules which can be fabricated on a local or regional basis and assembled within a suitable excavation at the user site. The modular integrated design allows the entire set of utilities to be installed within a single one-time trench leading from the utilities vault to each of one or several customer premises. A common utilities service entry module provides for service entry into each of the premises served. The invention includes the provision of various lifting and emplacement means for each module. A single vault enclosure assembly and the several common service entry modules and connecting sets of service lines comprise one unit of the invention. Said units can be replicated and distributed throughout an extended utilities development area as needed to serve the entire area. The set of modules for a single unit of the entire system comprises six basic modules:

1. A vault base module
Supports the modular vault enclosure assembly and an interior floor and drain
   2. One or more standard vault enclosure modules
Establishes the enclosed vault interior volume
   3. One or more short vault enclosure modules
Allows a smaller integral adjustment of the vault interior height and volume
   4. A cap module
Provides an upper enclosure for the vault interior and external access
   5. A cap extension module
Provides a means of matching the overall vault height to the local grade
   6. One or more common service entry modules
Provides an entry interface for utilities line service to each premises served

One unit of the integrated modular system consists of an underground modular vault enclosure assembly comprising one base module, one or more standard vault enclosure modules, one or more short vault enclosure modules, one cap module, one cap extension module, and one common service entry module located at each individual premises entry served by the underground modular vault enclosure assembly.

The current invention seeks to significantly reduce the installation cost of combined underground utilities services by using an integrated utilities vault, a single trench for all utilities delivered to one or more individual premises, and a unified interface device for entry into the premises. This system eliminates the risk of disturbing other underground lines caused by using individual trenching for each utility, and reduces the cost of initial installation, upgrading, and repair of such services.

The available vault enclosure volume allows service personnel access within the vault for connecting main utilities lines, through integrated sets of service lines, to the individual customer premises. Ample access allows each separate utility to service its own line interconnections within the vault and to each premises served. The modular design is adaptable to a wide variety of commercially available access ports or manholes and accommodates standard utilities conduits and connection hardware. The individual vault modules include aids for assembly and alignment and apply interface designs for joining the individual modules in assembly, said interfaces also providing resistance to lateral displacement forces as well as a means of sealing the vault interior against ground water leakage.

Various appropriate materials may be used for the bodies of the various modules including but not limited to: reinforced concrete, fiberglass, and fiber reinforced recycled plastics. The horizontal cross sectional shape of the underground modular vault and its associated modules may be of any appropriate shape including, but not limited to, rectangular, hexagonal, or other geometric shapes.

### BRIEF DESCRIPTION OF THE DRAWINGS

The following drawings are attached in explanation of the invention, the features of which are referenced within the detailed description of the invention. Note that, although the example horizontal cross sectional shape of the modular underground vault is rectangular as illustrated throughout the following drawings, said shape may be of any practicable multi-sided geometry.

FIG. 1: This figure presents a side view of the entire modular vault assembly showing all of the basic modules used to assemble the modular vault and a typical set of module wall penetrations for the utilities supplies to individual premises.

FIG. 2: This figure presents the adjacent side view of a vault of rectangular section and also shows all modules and a typical set of wall penetrations for intersection the main utility lines.

FIG. 3: This figure presents a top view of the vault assembly showing the cap and cap extension modules and a typical entry port for access into the underground vault.

FIG. 4: This figure illustrates a top view of the base module with its particular features.

FIG. 5: This figure presents a cross section of the common base module showing its particular design features.

FIG. 6: This figure illustrates particular features of the drainage configuration of the inner floor of the common base module

FIG. 7: This figure presents an isometric view of the base module and its features.

FIG. 8: This figure presents a detail of the base module interface.

FIG. 9: The figure shows the standard vault enclosure module which, when stacked with other vault enclosure modules, forms the inner space of the modular vault.

FIG. 10: This figure presents the short vault enclosure module of less depth than the standard vault enclosure module.

FIG. 11: This figure shows the assembly interface design applied to the upper facing wall edge of all common modules and an alternate design.

FIG. 12: This figure shows the assembly interface design of the downward facing wall edge of all common modules.

FIG. 13: This figure provides a side view of the common cap module showing its salient features.

FIG. 14: This figure provides a top view of the common cap module showing its salient features.

FIG. 15: This figure presents the downward facing interface detail used in the instance of the cap module only.

FIG. 16: This figure provides a side view of the cap module showing an example alternate location for the cap module to cap extension module interface and a typical location for an optional interface between the cap module and an above grade utilities pedestal.

FIG. 17: This figure provides a top view of the cap module as in FIG. 16.

FIG. 18: This figure provides an overall view of the common cap extension module which matches the vault access to the local grade level and houses the access port or manhole access cover.

FIG. 19: This figure provides a top view of the common cap extension module showing the installation of a typical access port cover.

FIG. 20: This figure shows a section of the common cap extension module and an example of the access port cover installation.

FIG. 21: This figure provides a cross sectional view of the installation within the upper facing module interface of a combined means of lifting the modules for placement and for holding the stacked modules in alignment when assembled.

FIG. 22: This figure depicts the placement of the lifting and alignment means at each corner of the upper facing module interface illustrated in FIG. 21

FIG. 23: This figure presents a view of the assembly of two adjacent modules using means illustrated in FIG. 21.

FIG. 24: This figure presents an alternate means of lifting the modules for assembly.

FIG. 25: This figure presents an overall view of the alternate lifting means shown in FIG. 24.

FIG. 26: This figure illustrates a third alternate means of lifting the common modules including a special lifting tool.

FIG. 27: This figure provides an overall view of the placement of alternate lifting means shown in FIGS. 22 and 24 on the various common modules in a typical modular integrated vault assembly.

FIG. 28: This figure illustrates a set of integrated utility lines within a single trench leading from the integrated modular underground vault enclosure to the customer premises with entry to the premises by means of a common entry module which is inserted as an integral element of the premises foundation and basement wall.

FIG. 29: This figure illustrates the details of the common premises service entrance module.

### DETAILED DESCRIPTION OF THE INVENTION

The invention comprises an integrated modular underground utilities vault and distribution enclosure system which provides an integrated interconnection means for all common utilities. One unit of said system is comprised of a single modular vault enclosure which integrates and connects a single set of main utility lines with one or more sets of integrated service lines to each of one or several utilities subscribers or customers served through the said utility vault. The vault and its distribution system are of modular design, allowing different vault enclosure depths and connection configurations to be achieved using a small set of common assembly modules which can be fabricated on a local or regional basis and assembled within a suitable excavation at the user site. The modular integrated design allows the entire set of utilities services to be installed within a single one-time trench leading from the utilities vault to each of one or several customer premises. A common utilities service entry module set within the premises foundation and basement outer wall provides for service entry into each of the served premises. The invention includes the provision of various lifting and emplacement means for each module. For applications to major housing or industrial park developments, a number of units of said modular vaults and associated service lines would be distributed throughout the development, each serving several individual utilities customers.

The Modular Underground Vault Enclosure Assembly:

The set of modules for a single Modular Integrated Underground Utilities Enclosure and Distribution System, in order of assembly, includes:

1. A vault base module

Supports the modular vault enclosure assembly and an interior floor and drain

2. One or more standard vault enclosure modules

Establishes the enclosed vault interior volume

3. One or more short vault enclosure modules

Allows a smaller integral adjustment of the vault interior height and volume

4. A cap module

Provides an upper enclosure for the vault interior and external access

5. A cap extension module

Provides a means of matching the overall vault height to the local grade

6. A common service entry module

Provides a common entry interface for utilities line services into the premises.

The above modules 1 through 5 are identified in the example modular vault enclosure assembly shown in FIGS. 1 and 2. Said assembly and modules are described in the following paragraphs in the order in which said modules and system elements would normally be assembled and installed.

An example complete assembly of the underground modular utility vault enclosure is illustrated in FIG. 1 and FIG. 2 showing two adjacent side views of an example modular vault assembly having a rectangular horizontal cross section and built up using the common vault modules 1 through 5 itemized above. Other appropriate horizontal cross sectional shapes can be used as well, but the rectangular shape will be practical in many installation cases and is shown as an example throughout this detailed description and in the accompanying set of drawings. All modules for a particular installation will have identical outer and inner wall configurations and identical cross sectional shape so as to be easily assembled in forming the vault assembly, with the exception that the cap module to cap extension module interface will be of reduced dimensions to accommodate service personnel entry means and commercial manhole cover or entrance protection.

FIG. 1 shows a side of the modular vault enclosure assembly which contains through wall ports for utility service lines leading from the interior of the vault enclosure to the utilities customer premises. Two complete adjacent sets of utilities line ports are shown in this example. Ports for two additional utilities sets can be provided on the opposite side of the vault, providing a total of four sets of utility lines to four individual customer premises in this illustrated embodiment of the invention. By adjusting the dimensional configuration of the common modules, provision for adding service line sets to additional premises can be provided within a single underground common utilities vault enclosure assembly.

A characteristic integrated set of utilities is indicated in FIG. 1 by the identifying function numbers shown below and include, but are not limited to:

7. Electric power
8. Communications (cable, fiber optics, etc.)

### 9. Water

### 10. Gas

### 11. Sewage

These through wall ports (7, 8, 9, 10, and 11) are provided within the vertical walls of the standard or short vault enclosure modules by either casting or cutting to meet custom locations and diameters determined by the requirements for a particular installation. These ports can also be provided as knock-out inserts available in selected configurations as a standard vault enclosure module option. Note that the dimensions of the overall horizontal cross sectional volume and the height within the modular underground vault enclosure will be such as to accommodate the necessary interconnections required for the full utilities set and a human operator to effect said interconnections and to perform any required maintenance or modifications thereto, and that all of the aforesaid modules 1 through 5 above will be of such dimensions that all interfaces will mate in the modular underground vault enclosure assembly.

FIG. 2 shows the adjacent sides of the modular vault to those of FIG. 1 (for the rectangular vault cross section instance) which contain through wall ports for the entry and exit of the main utility lines on opposite walls, one wall for entry and the opposite wall for exit. These main utilities lines include and are identified in FIG. 2 as, but not limited to:
12. Electric power
13. Communications (cable, fiber optics, etc.)
14. Water
15. Gas
16. Sewage

Connection of the one or several sets of utilities service lines to the main utilities lines will be made within the underground modular utilities vault enclosure. These through-wall ports (12, 13, 14, 15, and 16) are provided within the vertical walls of the standard or short vault enclosure modules by casting, cutting, or other means of forming to meet custom locations and diameters determined by the requirements for a particular installation. As with the utilities service lines, these ports can also be provided as knock-out inserts available in selected configurations as a standard vault enclosure module option.

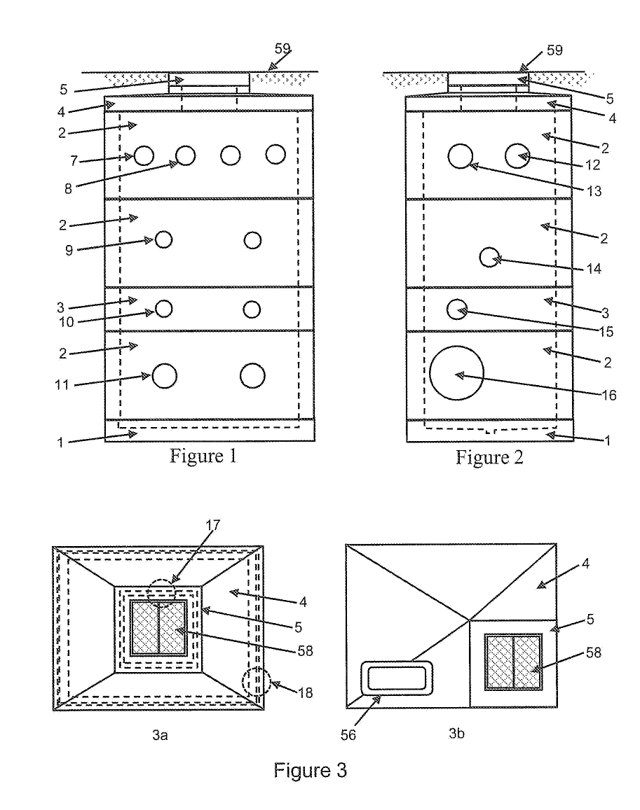

FIG. 3 illustrates a top view of the modular underground vault enclosure assembly showing the example rectangular horizontal cross section of the assembly and a central position for the cap extension module 5 set upon the cap module 4. The cap extension module 5 and its matching opening in the cap module 4 provide service personnel access to the modular vault enclosure. Note that the design of the cap module can be varied to locate the interface for the cap extension module anywhere within the outer horizontal periphery of the cap module. FIG. 3a shows a central location for the cap extension module 5 and FIG. 3b shows an alternate configuration. The access port 58, fitted to the upper edge of the cap extension module as an integral part of the cap extension module, is any of a number of commercially available access port covers of appropriate strength, weather sealing, and dimensions fitting the cap extension module. Hidden lines shown (dotted) indicate the matching interface contours of the cap module to cap extension module interface 17 and the cap module to standard or short vault enclosure module interface 18.

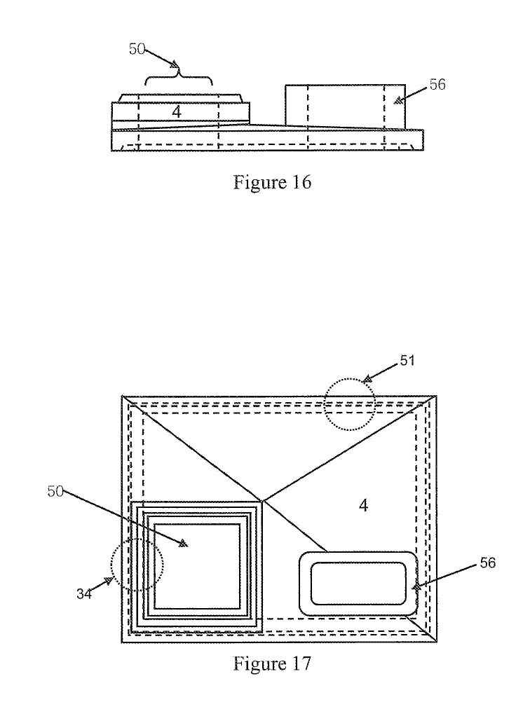

As noted above, FIG. 3b illustrates a top view of the modular underground vault assembly showing an example alternate location for the cap extension module 5 and vault enclosure entry interface as well as the location of an optional additional interface 56 allowing for the attachment of an above grade pedestal for electrical or communications interconnections where such access should be required by local usage or code (also see FIGS. 16 and 17). In this case, a matching extension of the cap module to the local grade level 59 would provide for the attachment of standard commercial above grade pedestals and interconnect boxes to the cap module with provision for internal connection to main lines within the modular underground vault enclosure. This above ground pedestal interface may be located anywhere within the outer horizontal periphery of the common cap module, provided that the cap extension module interface does not interfere with said location.

The Base Module:

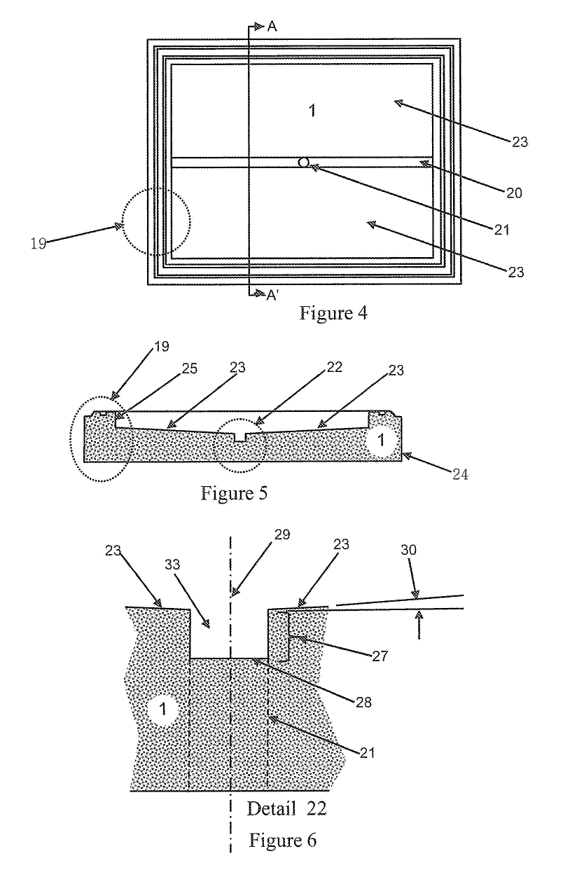

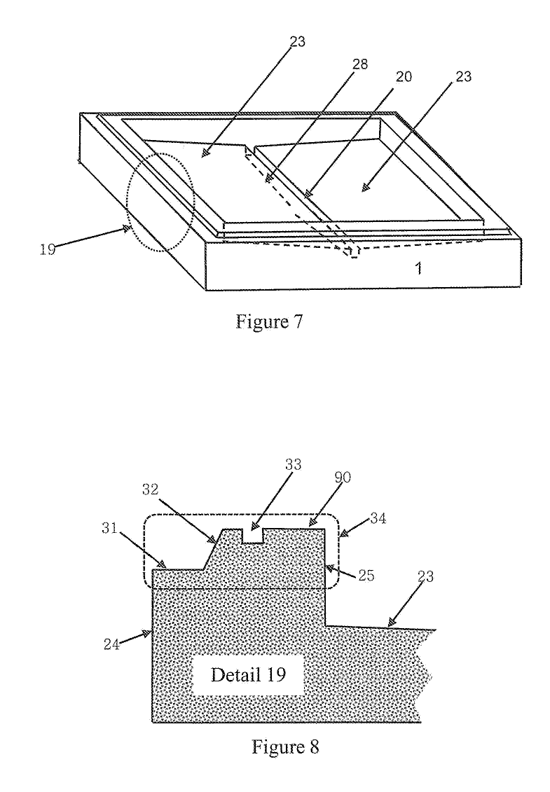

The Base Module 1 is the lowest module in the underground modular vault enclosure assembly. It forms the basis for the entire vault enclosure assembly and is placed within a suitable excavation with appropriate bedding for vault support and drainage. FIG. 4 illustrates a top view of the vault base module. The base module 1 upward facing interface 19 (described in detail below and in FIG. 8) mates with the downward facing interface of the standard vault enclosure module 2 or the short vault enclosure module 3, either of which may be stacked on top of the base module to form the interior of the modular vault enclosure assembly. Note that the upward facing contour 34 of this interface is identical to the upward facing interface contours of each of the other vault enclosure assembly modules, 2, 3, 4. The base module provides two planar floor surfaces 23 which are sloped downward to meet a central drainage trough 20 and a central drain hole means 21 leading to the porous bedding (gravel or other suitable material) upon which the base module rests within the installation excavation. FIG. 4 also notes a section A-A′ which is shown in FIG. 5 showing the assembly interface 19, and inner wall 25 forming an interior basin within the base module, the two sloping floor surfaces 23 and the drainage trough detail 22. Detail 22 is described in FIG. 6 which shows the trough 20, with a bottom 28 located at depth 27 which is tapered downward from the intersection of the trough 20 with the inner basin walls 25 to the central drainage means 21. The trough is centered on the vault enclosure centerline 29. Also illustrated is the slope of the two floor surfaces 23 at angle 30. These design features provide for positive drainage of any interior moisture which might accumulate within the vault enclosure. FIG. 7 provides an overall isometric view of the base module again showing the peripheral interface 19, the inner basin formed by the inner walls 25, the trough 20 and the tapered bottom of the trough 28. FIG. 8 illustrates the peripheral interface profile 19 of the base module. The vertical face 24 forms the outside surface of the base module. Lower load bearing surface 31 and upper load bearing surface 90 support the entire modular vault enclosure assembly. The tapered surface 32 joining the lower and upper load bearing surfaces provides a means of centering the stacked modules one upon the other and of resisting lateral forces which otherwise might shift the stacked modules with respect to each other. A channel 33 may be inserted to provide for the use of O-ring or other gasket around the periphery of the interface to seal the juncture of the upward facing interface contour 34 with downward facing contour 35 or with downward facing interface contour 51 in the case of the cap module (described below and in FIG. 15). The short inner wall 25 of the base module and sloping floor 23 form a basin within the base module which is the lower internal terminus of the interior of the vault enclosure assembly. The bottom outer face 91 of the base module is flat and supports the entire weight of the vault enclosure assembly, resting upon an underlayment of suitable porous material such as gravel.

The Vault Enclosure Modules:

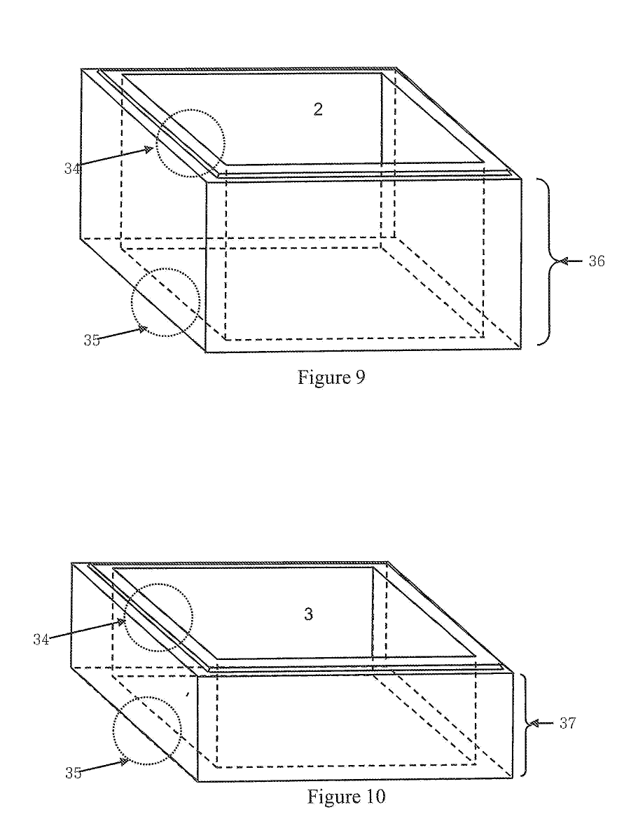

The standard vault enclosure module 2 forms the basic unit for building the vault enclosure. It basic features are shown in FIG. 9. A characteristic rectangular horizontal cross sectional shape is shown but the features described below are applicable to alternate cross sectional shapes as well. The wall height 36 forms the vertical depth of this module. Wall upper and lower interfaces are of uniform thickness and profile throughout. A vertically stacked assembly of this module with one or more others, including one or more short vault enclosure modules (FIG. 10) if required, form the internal volume available within the modular underground vault assembly. The module to module interfaces between adjacent wall interfaces are formed by the upward facing wall edge interface contour 34, and by the downward facing wall edge interface contour 35. Since the through wall main and service utility line locations and diameters will be determined by the requirements for specific installations, these through-wall access ports are not shown in the FIG. 4 illustration of the standard vault enclosure module, the overall features and dimensions of which will remain constant in all cases with the main and service utility line ports being inserted during fabrication in either knock-out or through ports as required for particular installations.

The short vault enclosure module 3, shown in FIG. 10, is in every way identical with the standard vault enclosure module with the exception that its depth 37 is a fraction of the standard module depth 36, allowing for a finer adjustment of the overall depth of the vault enclosure assembly to meet particular installation requirements for overall depth and for particular integrated utility line configurations.

Standard Assembly Interface Profiles:

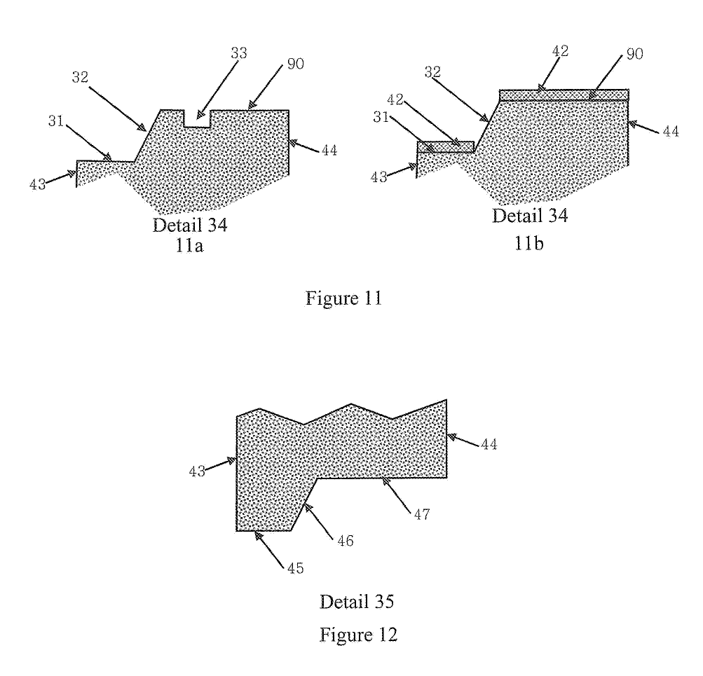

The upward facing profiles of all modules are identical and of matching dimensions for assembly into the complete modular vault enclosure assembly and are shown in FIG. 11. FIG. 11 reflects upward facing interface detail 34 in FIGS. 9, 10, 13, 14, 17 and 21 and in detail 19 in FIGS. 4, 5, 7, and 8. Portions of the inner 44 and outer 43 walls of the modules are shown as a part of these profiles. The basic configuration of the upward facing interface is that of a lower load bearing surface 31 and an upper load bearing surface 90 which surfaces lie in a plane perpendicular to the vertical axis and to local gravity. These surfaces bear the entire weight of the vault enclosure assembly place above the interface. Surfaces 31 and 90 are joined by the angled plane surface 32 which assists in the alignment of the modules during assembly and provide resistance against lateral displacement forces which otherwise might misalign the modules, one with respect to the other. Two means of sealing the interface against moisture penetration are possible. FIG. 11a illustrates an interface which includes a groove 33 for the insertion of an O-ring or other gasket to provide sealing of the interface against moisture and FIG. 11b illustrates an alternate embodiment using a mastic sheet or ribbon placed on the lower and upper load bearing surfaces 31 and 90, or alternatively on either one or the other load bearing surface, as a sealing means.

FIG. 12 illustrates the matching downward facing standard interface detail 35 which is used for modules 2, 3, and 5 and as shown in FIGS. 9, 10, 18 and 20. As in FIG. 11 illustrating interface detail 34, FIG. 12 includes an indication of the outer 43 and inner 44 walls of the vault enclosure. The downward facing horizontal load bearing surfaces 45 and 47 interface with the corresponding upward facing horizontal load bearing surfaces 31 and 90 of FIG. 11. The angled plane surface 46 interfaces with the corresponding surface 32 of the upward facing interface in FIG. 11 to provide alignment of the adjacent modules and resistance to any lateral displacement forces acting upon the assembled modules.

The downward facing interface of the cap module, illustrated in FIG. 15, is somewhat different from the standard module configuration 35, FIG. 15, is 12, and is described below.

The Cap Module:

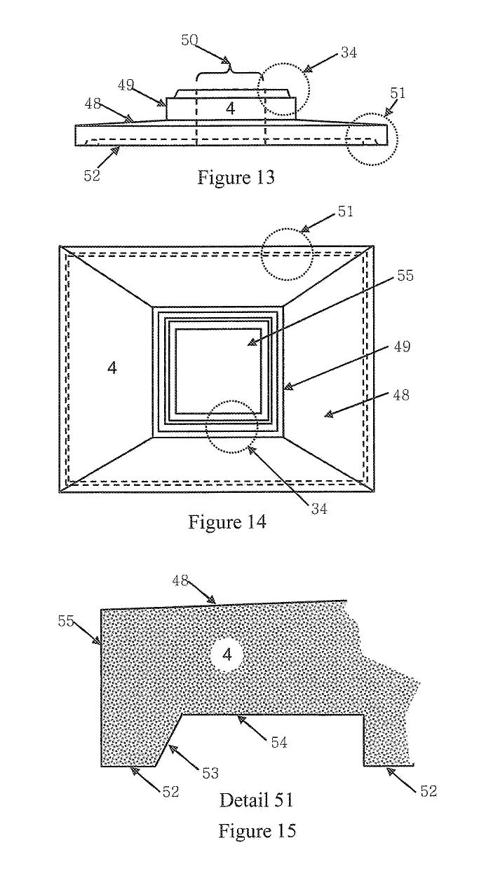

The cap module provides the upper terminus and roof of the vault enclosure assembly. A side view of the cap module is shown in FIG. 13. It's features are that of a flat bottom 52, forming the interior ceiling of the vault enclosure, and assembly interface profile detail 51, an extension of the upward facing interface for the cap extension module 48, an access opening 50 and associated upward facing interface detail 34 which is elevated a certain distance 49 from the upper cap module surface 48 which is tapered upward from the outer periphery of the cap module to the base of the cap extension interface riser 49 in order to divert any moisture at the upper surface of the cap module to the side of the vault enclosure assembly.

A top view of the cap module is provided in FIG. 14 which again shows the example central location of the cap module to cap extension module upward facing interface contour 34, the access opening 50 and the outer periphery of the interface 34, the slanted upper cap surface 48, and the lower facing interface contour 51 which mates with the upper facing interface configuration detail 34 of the underlying vault enclosure module (either standard 2 or short 3).

FIG. 15 illustrates the particular configuration of the downward facing interface contour of the cap module. In this case, an inset is provided into the outer periphery of the cap module lower surface 52 which surface provides a lower load bearing horizontal plane surface to match with the lower load bearing surface of the upward facing vault enclosure profile 34, and inset upper load bearing surface 54 which matches the corresponding upper surface in profile 34, and a slanted plane surface 53 which mates with the corresponding slanted plane surface 32 of profile 34 to assist in alignment of the two modules and in resisting lateral displacement forces.

FIGS. 16 (side view) and 17 (top view) illustrate alternate configurations for the location of the cap module to cap extension module interface within the cap module area. An example location of an additional interface 56 providing for the use of an above grade utilities pedestal is also illustrated. Hidden lines indicate the downward facing interface profile 51 inset into the lower surface of the cap module.

The Cap Extension Module:

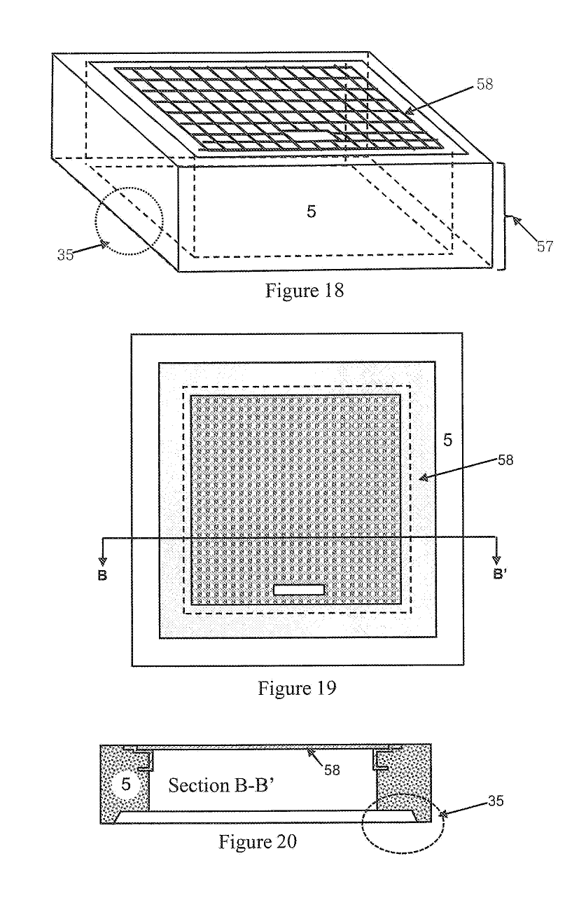

The cap extension module 5, illustrated in FIG. 18, provides a means of matching the upper termination of the underground modular vault enclosure assembly to the local grade level and as a means of integrating a commercially available access port cover or manhole cover to the vault assembly. The cap extension module depth 57 is designed to match the vault enclosure assembly depth to the local grade and may be varied to meet particular system installation requirements. The downward facing interface contour 35 matches with the upward facing contour 34 of the cap module as noted in FIGS. 14 and 17. The commercially available access port cover 58 is attached to or inserted as an integral assembly of the cap extension module. FIG. 19 presents a top view of the cap extension module, a depiction of a representative cover 58, and the designation of an example cross section of the cap extension module B-B′. FIG. 20 presents the cross section B-B′ again showing the downward facing interface contour 35 and the integral insertion of a characteristic access port cover 58 within the cap extension module body.

Lifting Means for Module Assembly:

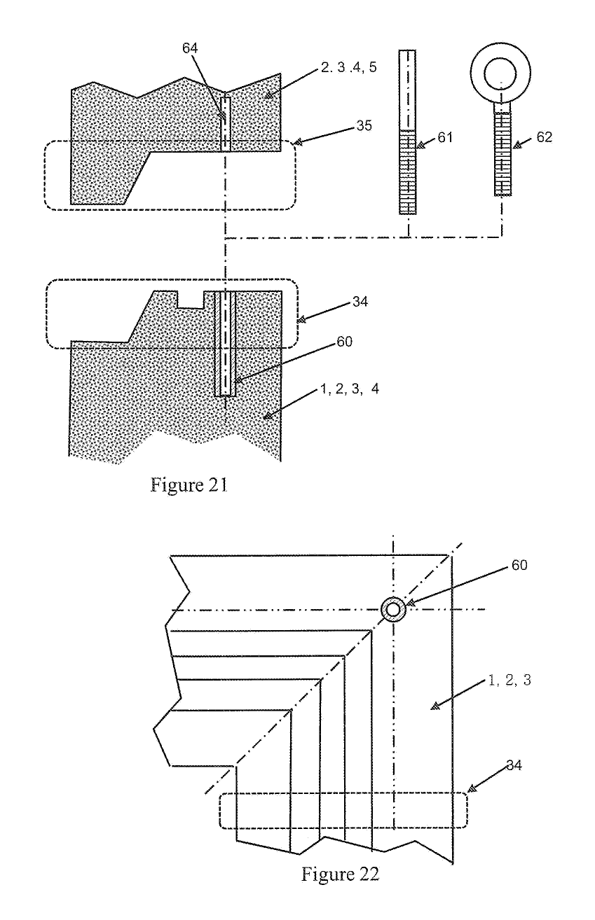

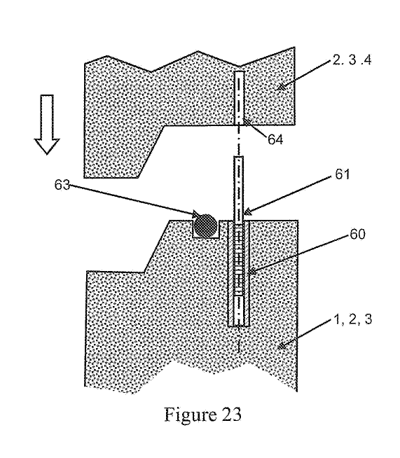

A variety of lifting means can be adapted for integration with the Modular underground vault enclosure as described above. One such means is described in FIGS. 21 and 22. In this embodiment, an internally threaded cylinder 60 of suitable diameter, thread design, and material is cast or otherwise secured within any of the upward facing interfaces 34 of the vault enclosure modules 1, 2, 3, or 4. However, note that in applying this particular means, the cap module to cap extension module interface must be centered on the vertical axis of the vault enclosure to assure balanced lifting forces on the cap module. The seating depth and length of the threaded cylinder will depend upon the shear strength characteristics of the interface between the embedded cylinder and the module body material. The cylinder will be inserted into the symmetric extremities of the upward facing interfaces to provide uniform support for each module based on its horizontal cross section and weight distribution. A typical location for a rectangular horizontal cross section vault configuration is shown in FIG. 22, the four cylinders being located on the diagonal intersection of the rectangle walls at the four corners of the module. In order to lift the module into position for assembly, a standard eye-bolt of matching diameter, thread design, and shank length is threaded into these cylinders and coupled to the lifting means (derrick, crane, or other lifting device). Once assembled, said eye-bolts will be removed and a straight rod of uniform diameter and appropriate length will be threaded into the threaded cylinder and aligned with a corresponding cylindrical recess 64 in the matching downward facing vault module interface 35 in order to aid in module alignment and will be left in place after assembly to provide resistant against lateral displacement forces which might otherwise shift adjacent vault modules with respect to each other. FIG. 23 indicates the assembly of two adjacent vault modules using this lifting embodiment and also shows the insertion of an O-ring or gasket 63 within the sealing trough 33 of the upward facing interface profile 34 as shown in previous FIGS. 8 and 11a.

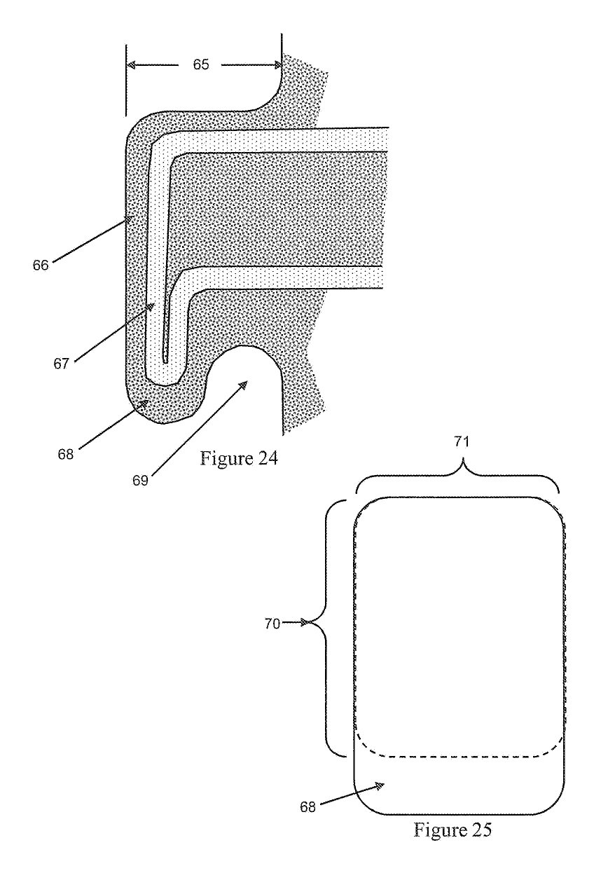

An alternate lifting means is illustrated in FIGS. 24 and 25. In this embodiment a protrusion 66 of the same material as used in the vault module is molded into the module inner or outer vertical wall at an added thickness 65 which is approximately twice the thickness of a horizontal recess 69 and lip 68 which together provide an anchor for a lifting rope or cable. These protrusions are to be located at equidistant points at the extremities of the horizontal cross sectional shapes of the vault module set. Reinforcing elements 67 may be included within the protrusion and extending into the module body to provide added shear resistance during lifting. The root length 70 and width 71 of the protrusion provide the basic shear strength to support the various modules during lifting and placement of the vault modules.

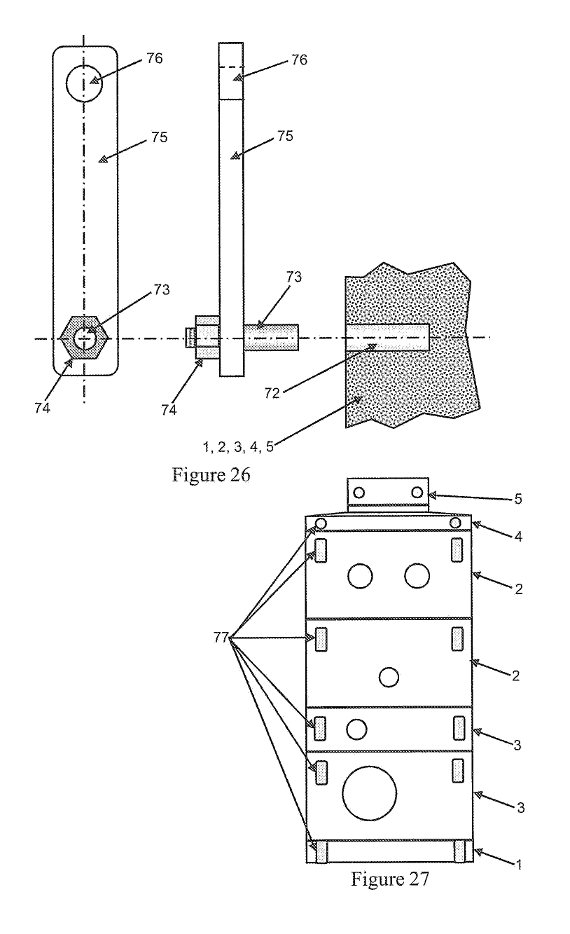

A third embodiment of a lifting and assembly means for the modular vault enclosure assembly is illustrated in FIG. 26. In this embodiment, a cylindrical recess 72 of uniform internal diameter is let into the body of the vault module at an equidistant position in the outside wall extremities of the vault horizontal cross sectional shape, in order to provide a uniform lifting geometry. The depth of the cylindrical recess will be determined by the wall thickness of the module assembly interfaces and the compressive strength of the module material. A set of identical lifting bar assemblies (one for each recess) will intersect with said recess and provide an attachment point for standard lifting device (derrick, crane, or other lifting device). The lifting bar assembly comprises a straight flat bar 75 of rectangular transverse cross section and having a cantilevered rod 73 secured to the lower extremity of the bar by weld or nut 74 to engage the cylindrical recess 72. The rod is of such diameter as to provide an easy slip fit within the cylindrical recess and to bind against the interior surfaces of the recess in order to transfer lifting force to the vault module from the lifting bar assembly. This particular lifting means embodiment is most efficient using a vertical lift force applied at the upper end of each bar, which may require the use of a standard spreader to provide a single lift point for the lifting device.

FIG. 27 illustrates characteristic module locations for the various lifting means described above relative to the complete underground vault enclosure assembly.

The Modular Integrated Utilities Distribution System:

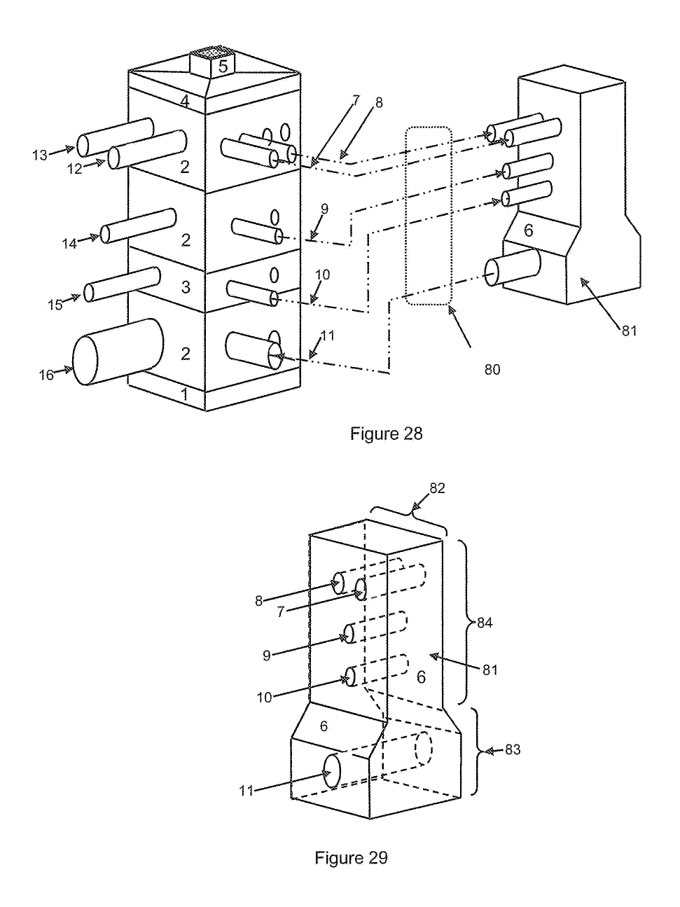

A unique feature of the Modular Integrated Underground Utilities Enclosure and Distribution System is its use of a single trench and a unified set of utilities conduits so that only a single excavation is required for each utilities service customer and that any future modification of utilities services to each or any individual customer or premises can be accomplished through said conduit set, both reducing the cost of such modification and minimizing the risk of damage to other unrelated utilities services by such modifications. The unified distribution system is illustrated in FIG. 28 showing the central underground modular integrated utilities vault enclosure assembly (modules 1, 2, 3, 4 and 5), the main utilities lines (12, 13, 14, 15, and 16) intercepted by the vault enclosure, and the set of utilities service lines 80 to a single customer or premises (comprised of individual utilities service lines 7, 8, 9, 10, and 11). The service entrance to each customer is integrated within a common service entry module 6. Each vault enclosure assembly can service a number of individual customers or premises branching from the vault, each with its own set of utilities service lines 80, each set of lines 80 being within a single trench leading from the vault enclosure assembly to each customer location. If required, interconnection for certain utilities services may be provided within an above ground pedestal which can be integrated with the vault enclosure assembly as illustrated previously in FIGS. 3, 16, and 17.

The integrated common service entry module 6 is illustrated in FIG. 29. This module comprises a set of wall penetrations or interconnecting conduits 7, 8, 9, 10, and 11 corresponding with the customer terminus of the integrated set of utilities lines described in FIG. 28 and above. The general shape of the entry module 6 is such as to mate with the normal foundation and basement wall configuration and thickness to be used within the development to which the overall modular system is to be applied. The module 6 is designed to be inserted during the pouring of the foundation and the pouring or layup of the basement wall structure so as to be an integral part of that structure. The lower expanded portion 83 of module 6 thickness is intended to match the foundation. The upper portion 84 of the module is intended to match the thickness and height of the standard basement wall configuration as it is built up from the foundation. The sides of module 81 may be contoured or profiled so as to enhance the bonding with the materials of the customer foundation and basement wall construction.

What is claimed is:

1. A modular integrated underground utilities enclosure and distribution system comprising an underground vault enclosure assembled using a set of standard modules to wit: a base module forming the base of said vault assembly, one or more standard enclosure modules forming the interior of said vault assembly, one or more short enclosure modules also forming the interior of said vault assembly allowing a finer adjustment in overall height of said vault enclosure than that available using only the said standard enclosure module, a cap module providing an upper cap and a roof or ceiling terminus of said vault assembly, a cap extension module providing grade level access to the interior of said vault assembly and penetrating through said cap module, an integrated set of utilities service conduits running from said integrated vault assembly to each of several utilities customers or user premises, a common premises service entry module for each premises served, and a common set of wall penetrations within the walls of said standard and short enclosure modules allowing the entrance and exit of utilities main lines into and out of said vault enclosure assembly and the several sets of premises integrated service lines to exit said vault enclosure, said service lines to be interconnected with their associated main utilities lines within said vault enclosure.

2. Apparatus according to claim 1 in which the said base module, standard or short enclosure modules, and cap module of claim 1 are formed with a standard and identical upward facing interface profile so shaped as to mate with a corresponding downward facing standard interface profile formed as an integral part of said standard and short enclosure modules, said cap module, and said cap extension module, and thereby joining the outer periphery of said modules to that of the immediately superior modules according to the vault enclosure module assembly sequence, said upward facing interface profile to comprise a lower plane load bearing surface beginning at the outer wall of said modules and everywhere perpendicular to the vertical axis of the module and the vault enclosure assembly, a next adjacent angled plane surface extending upward for an appropriate distance and at such an angle as to facilitate alignment upon module to module assembly and to assure resistance to relative lateral displacement forces between adjacent stacked modules, and an upper plane load bearing surface parallel to said lower plane load bearing surface and immediately adjoining said angled plane surface and terminating at the inside wall of the module, the intersections of all of the said interface profile surfaces to be parallel to and everywhere equidistant from the outer terminus of the inner and outer vertical walls of said module, said walls being parallel to each other.

3. Apparatus according to claim 2 in which the said upward facing module interface profile, containing said upper plane load bearing surface as an integral part of said profile, includes a slot or groove of appropriate shape and dimensions which is formed within the body of said modules so as to extend downward from the upper load bearing plane surface of said profile into said module body and of suitable dimensions as to hold an O-ring or other gasket of appropriate size and material so as to provide a watertight seal between the adjoining upper and lower facing module interface profiles when two adjacent modules are assembled to form said vault enclosure assembly, said slot or groove to be everywhere equidistant from the intersection of said upper plane load bearing surface intersection with the inner wall of said module and at such a distance as to approximately bisect said upper load bearing surface between its intersection with the inner wall of said module and/or with the adjacent angled plane surface of said interface profile.

4. Apparatus according to claim 2 in which the said upward facing module interface profile, containing said lower and upper plane load bearing surfaces as integral parts of said profile, is covered with a gasket or mastic layer of uniform thickness and appropriate compressive strength to provide a watertight seal between the adjoining upper and lower facing module interface profiles when two adjacent modules are assembled to form said vault enclosure assembly.

5. Apparatus according to claim 1 in which said base module is of sufficient overall thickness as to sustain the combined fully assembled weight of said vault enclosure assembly, includes an interior vertical wall height sufficient for form an internal basin and floor for said vault enclosure, said floor to everywhere slope downward toward the plane bottom outer surface of said base module and to be bisected by a drain trough of suitable dimensions, the bottom of said drain trough to slope downward from its outer extremities located at the inner walls of said vault enclosure toward a central drain hole, of suitable dimensions, which extends through the bottom thickness of said base module connecting the central drain bottom to the outside of the outer bottom surface, the whole to provide internal drainage of entrapped water or other liquid to an appropriate bedding substrate for said vault enclosure assembly.

6. Apparatus according to claim 1 in which the horizontal cross section of said vault enclosure may be of any appropriate geometry, including, but not limited to: rectangular, hexagonal, or other multisided or rounded geometric configurations.

7. Apparatus according to claim 1 in which said cap module provides for vertical entry into said vault enclosure from the top of the enclosure, said entry means to be generally smaller in horizontal size, extent, and area than that of the periphery of the overall horizontal cross section of said vault enclosure and said cap module and placed at any convenient location and orientation within the overall horizontal extent of said cap module.

8. Apparatus according to claim 2 in which the periphery of said vertical entry means through said cap module is defined with walls having the same upward facing interface profile as that of other said modules forming the interior of said vault enclosure assembly and mating with the corresponding downward facing interface profile of said cap extension module.

9. Apparatus according to claim 7 in which the periphery of said vertical entry means through said cap module is defined with walls having the same upward facing interface profile as that of other said modules forming the interior of said vault enclosure assembly and mating with the corresponding downward facing interface profile of said cap extension module.

10. Apparatus according to claims 1 or 7 in which said cap module provides for an additional interface with vertical access to the interior of said vault enclosure allowing the use of a standard above grade pedestal for electrical, communications, and other utilities within the above ground pedestal, said interconnections being interfaced with associated utility main lines from within said vault enclosure interior, said interface to be located at any location within the horizontal extend and periphery of said cap module.

11. Apparatus according to claims 1, 2, 8 or 9 in which said cap extension module includes said downward facing interface profile of such dimensions as to mate with said upward facing interface profile of said cap module and within which any standard entry cover or manhole cover may be integrated or installed in order to provide interior protection from surface traffic and weather, and of such vertical extent as to provide grade level access to said vault enclosure interior.

12. Apparatus according to claim 1 in which a means of lifting and assembling the various said modules is incorporated as an integral part of said modules, said means comprised of an internally threaded tube vertically inserted at uniform and symmetrical points into the upward facing interface profile of said modules, of such diameter, material, and threat configuration as to allow said modules containing said lifting means to be safely lifted and set in place during assembly of said vault enclosure by means of common eyebolts of suitable strength and matching thread to be inserted in each of the said internally threaded tubes, said eyebolts to be removed upon placement in said vault enclosure assembly and in the place of said eye-bolts, a straight rod of suitable material and length to be inserted to mate with a matching cylindrical recess cut into the matching downward facing interface profile of the next superior module and of suitable diameter and depth to receive the protruding portion of said straight rod.

13. An alternate apparatus in accordance with claim 1 in which a means of lifting and assembling the various said modules is incorporated as an integral part of said modules, said means comprised of a protrusion fabricated as an integral or fastened part of the exterior or interior walls of said modules and of such shape as to form an integral lip and groove such that a lifting loop of rope or cable may be placed securely around each such protrusion for lifting and placing said modules during assembly, said protrusions to be located symmetrically about the periphery of said modules so as to permit uniform and balanced lifting.

14. An alternate apparatus in accordance with claim 1 in which a means of lifting and assembling the various said modules is incorporated as an integral part of said modules and using a special lifting tool, said means comprised of a set of cylindrical or other shaped recesses formed or cut into the periphery of said modules of sufficient size and depth as to permit safe lifting of said modules by means of a special lifting tool comprising a matching jamb rod, which is to be cantilevered from a lifting bar of suitable material, cross section and length, said cantilevered bar to be secured to said lining bar by means of weld, threaded nut, or other appropriate mechanical means, the upper end of said lifting bar to be provided with a suitable eye-bolt or hole for attachment of common lifting means to the said modules.

15. Apparatus in accordance with claim 1 in which a common premises service entry module provides a common integrated means of coupling the set of utility service lines and associated conduits leading from said integrated vault enclosure to each served premises or customer served by said vault enclosure, said service entry module to comprise a unified block of such shape and size as to allow direct incorporation as an integral portion of the standard foundation and basement wall of each served premises, appropriate through ports or holes being provided through the said service entry module which match the diameters of the set of integrated utility lines and associated conduits, said service entry module having a base of expanded thickness as to serve as an element of the premises foundation and having an upper extent of such thickness a to match and become an incorporated part of the premises basement wall.

16. Apparatus in accordance with claim 1 in which the materials used to form the various said modules which form the modular integrated underground utilities enclosure and distribution system may be of a variety of suitable materials including, but not limited to, reinforced concrete, fiberglass, recycled plastic, and other materials having excellent in-ground and weather exposure lifetime and appropriate material strength characteristics and low cost fabrication techniques.
